(19) United States
(12) Patent Application Publication
(10) Pub. No.: US 2016/0242368 A1
(43) Pub. Date: Aug. 25, 2016

(54) Garden Planting Template and Weed Barrier

(71) Applicant: Torrinella Farm, LLC, West Chester, PA (US)

(72) Inventor: David G. Levine, West Chester, PA (US)

(73) Assignee: Torrinella Farm, LLC, West Chester, PA (US)

(21) Appl. No.: 15/047,331

(22) Filed: Feb. 18, 2016

Related U.S. Application Data
(60) Provisional application No. 62/118,544, filed on Feb. 20, 2015.

(51) Int. Cl. A01G 13/00; A01G 1/00

(52) U.S. Cl. CPC A01G 13/0268; A01G 1/001

(57) ABSTRACT

Embodiments of a system and method for planting vegetables in raised beds are disclosed, The system includes a landscape fabric having clearly visible planting sites on the surface where a gardener can easily tear pre-formed perforated sites to create access holes to the soil. The access holes provide the proper spacing for the selected plant or seed type. In particular embodiments, multiple vegetable types can be planted with the proper spacing by simply selecting the proper hole. The landscape fabric is a porous material allowing passage of fluids and preventing germination of weeds.

### CROSS-REFERENCE TO RELATED APPLICATIONS

This application claims the benefit of U.S. Provisional Application No. 62/118,544, filed Feb. 20, 2015 and incorporated by reference in its entirety,

### FIELD OF THE INVENTION

This disclosure relates to gardening. More particularly, the disclosed subject matter relates to a template design overlying landscape fabric with pre-fabricated perforations for optimized cutouts to ensure proper plant spacing and ease of planting while providing weed protection within a single landscape cover.

### BACKGROUND OF THE INVENTION

Backyard gardening is becoming more popular every year. Two of the more frustrating aspects of gardening are proper spacing of plants and prevention of weed growth. A variety of planting guides are available to demonstrate where plants should be placed but that still requires manually measuring the distance for each plant.

Weeding is one of the timeliest chores for vegetable gardeners when growing vegetables. A variety of chemical and physical devices have been developed to decrease the growth of weeds, but these require time applying the chemical and physically removing the weed. Over the course of a growing season it becomes a burden to continually perform these tasks in order to keep a garden weed free.

There is a need for a device that can physically aid in the rapid planting of plants and can double as a weed preventative barrier throughout the growing season.

### SUMMARY OF THE INVENTION

The present invention incorporates a landscape fabric having an overlay design that optimizes the spacing of vegetables in a raised bed garden. One embodiment comprises an overlay design of 12 inch squares, or 12 in×12 in square units, along the entire planting surface area of the raised bed to guide the gardener in planting within each square unit. A maximum number of nine (9) uniformly spaced site markings are available within each 12 in×12 in square unit for planting almost any type of garden vegetable. The gardener selects specific markings based on the plant type which provides the precise planting location for optimum spacing. The gardener creates access holes around the specific markings to open an area just large enough to plant. With a nine site plant markings in the configuration provided in the present invention, the gardener has multiple planting options readily available for planting different plant types for each square unit.

A further embodiment of the present invention incorporates pre-formed perforations for planting at the access holes defined by the nine site plant markings. Perforations in the landscape fabric allow the gardener to quickly determine the planting pattern and easily create a small access hole into the soil where the plant or seed will be planted. A further embodiment comprises pre-formed perforations along the perimeter of the square unit which allow larger portions of the soil to be exposed.

Still another embodiment incorporates landscape fabric in widths commonly found in most raised bed designs and includes pre-formed perforations transecting the length of the roll at 4 feet, 5 feet, 8 feet, 10 feet, or any suitable length that would forma single raised bed sheet. These perforations enable the gardener to easily remove the remaining portion of a roll without the need of scissors or other cutting means.

Another aspect of the present invention is the landscape fabric itself which is preferably a biodegradable composition that, when applied, will prevent weed growth over a complete growing season. While other landscape fabric compositions known in the art are considered, the fabric should generally be able to prevent weed block over the course of a growing season.

### BRIEF DESCRIPTION OF THE DRAWINGS

FIG. 1: shown is an example of a 4 foot by 4 foot square landscape fabric of the present invention, having areas that are marked with lines for plant placement. Each of the black lines or access holes are perforated or mechanically prepared for easy tearing.

FIG. 2: shows an expanded view of one embodiment for a square unit showing the 9 access holes with the center hole having additional linear perforations for planting larger plants.

FIG. 3: shows two representative orientations for sizing plants. Panel A depicts one arrangement for plants requiring approximately 6 inch spacing. Panel B depicts plants having less requirements for spacing.

FIG. 4: shows a drawing of a typical roll having pre-formed perforations in the landscape material at intervals along the roll that when transected form section to cover the complete planting bed and prevent weed growth.

FIG. 5: Depicts a representation of a typical planting scheme selected by a gardener for planting in a 4 foot wide by 8 foot long garden vegetable bed.

### DESCRIPTION OF THE PREFERRED EMBODIMENTS

The figures and descriptions of the present invention are presented in a simplified format to illustrate elements that are relevant for a clear understanding of the present invention, while eliminating, for purposes of clarity, other elements found in typical vegetable garden beds. Those of ordinary skill in the art will recognize that other elements may be desirable and/or required in order to implement the present invention. Because such elements are well known in the art and because they do not facilitate a better understanding of the present invention, a discussion of such elements is not provided herein. It should also to be understood that the drawings included herewith only provide diagrammatic representations of the presently preferred structures of the invention and that other structures falling within the scope of the present invention may include structures different than those shown in the drawings.

In order to provide for the optimal growth of plants, especially vegetables, the spacing between individual plants is an important factor and varies with each specific plant. Some plants such as potatoes require a large amount of space between individual plants whereas other plants such as carrots require only a small amount of space between plants. Additionally in a row of particular plants, spacing between plants will usually be slightly less than the space between one plant type and another plant type. Spacing can sometimes be determined by the expected size of a fully-grown plant, however this is not always the case. For example potatoes require a large amount of space due to the size of the plant underneath the soil. Thus without a guide, it is therefore difficult to determine an optimal spacing between plants.

In addition, optimal plant growth is encouraged with the use of landscape fabric across the surface of the soil designated as the planting area. Landscape fabric is a textile material used to control weeds by inhibiting sunlight. The fabric is normally placed in the area surrounding the desirable plants in areas where other growth is to be prevented. The fabric itself is made from synthetic or organic materials, sometimes from recycled sources. These fabrics are designed to prevent entry of sunlight while allowing water and other nutrients to permeate. When the landscape fabric is used accordingly across the planting area, perfect spacing of plants is obtained with no weed growth, unarming of the soil and a decreased watering requirement to increase the yield from individual plants.

The present invention provides a universal overlay planting design on landscape fabric which creates an optimum planting distance between most individual vegetable plants and eliminates the need to individually measure distances for each planting.

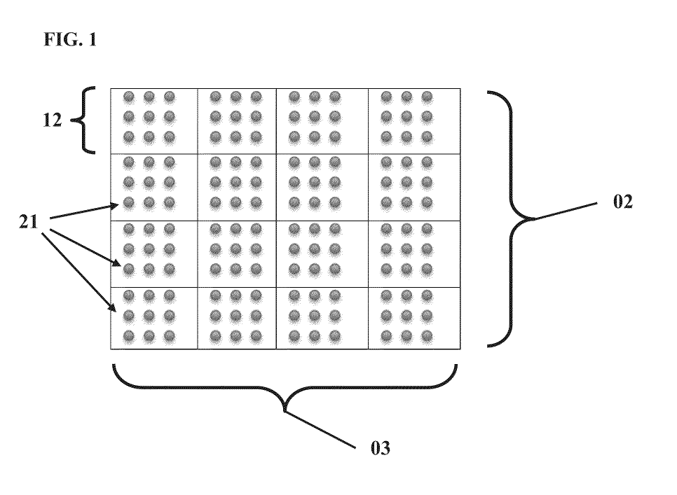

One embodiment of the present invention incorporates an overlay planting design on landscape fabric used on raised vegetable garden beds. A typical overlay design used in a raised bed is shown in FIG. 1, having a 4 foot width (02) and a 4 foot length (03). in this design, 12 in×12 in square units (12) demarcate clusters of nine equally spaced individual planting sites (21). While other overall widths and lengths are considered as discussed herein, the square units (12), each with nine equally spaced planting sites (21) are incorporated in the overlay design in all landscape sizes. The design allows the gardener to select specific sites (21) for creating access holes having optimum planting distances for most types of garden vegetable plants. The gardener can simply follow a prefabricated garden plan found online or any planting scheme suitable for the selected vegetable plants.

In another embodiment related to each specific site (21), small potential access holes are defined by pre-fabricated perforations so that if a specific site (21) is selected for planting the gardener simply tears the perforations to expose a portion of the planting soil at the site of the planting area, creating a small access hole for target plants or seeds. Should planting selections mandate an even larger access area, the gardener can simply tear the perforations along the perimeter of a specific square unit (12) to expose a large surface area of soil. The final selection of access holes and/or exposed square unites can he customized for an individual gardener's planting scheme. The process allows for significantly easier and faster planting in a raised vegetable bed and ensures proper spacing and weed prevention for selected vegetable plants.

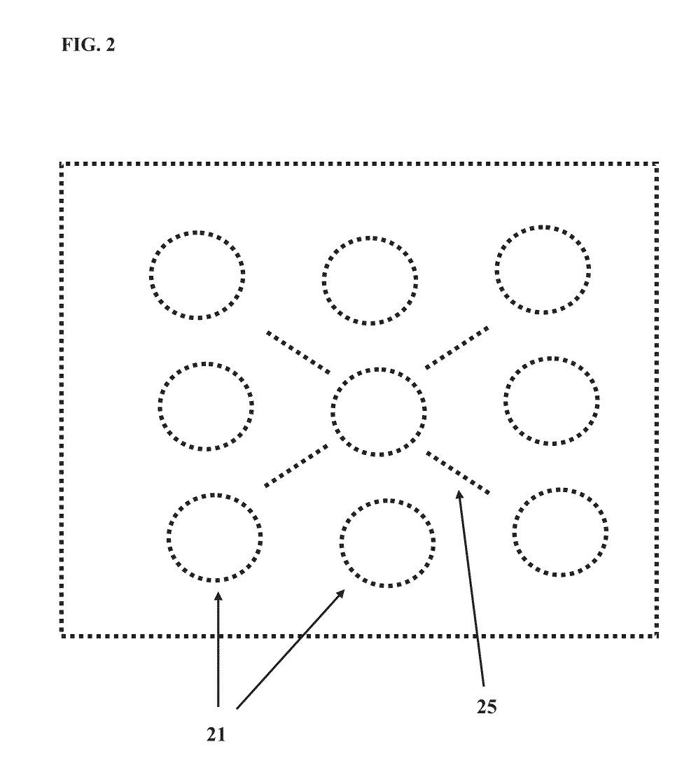

Still another embodiment incorporates perforated access holes (21) having a 2.5 inch diameter for allowing easy planting of seeds which are started in 1 to 2 inch standard planters. For larger plants requiring additional surface access, a center access hole further incorporating four equally spaced linear perforations (25) radiating outwardly from the circumference of the center access hole allows additional planting surface as shown in FIG. 2. These additional linear perforations provide for planting larger plants. The edges formed from the perforations are folded back down for continued weed control. Larger plants may include, but not limited to, broccoli, cabbage, cauliflower, collards, eggplant, kale, melons peppers, tomatoes, squash, or zucchini.

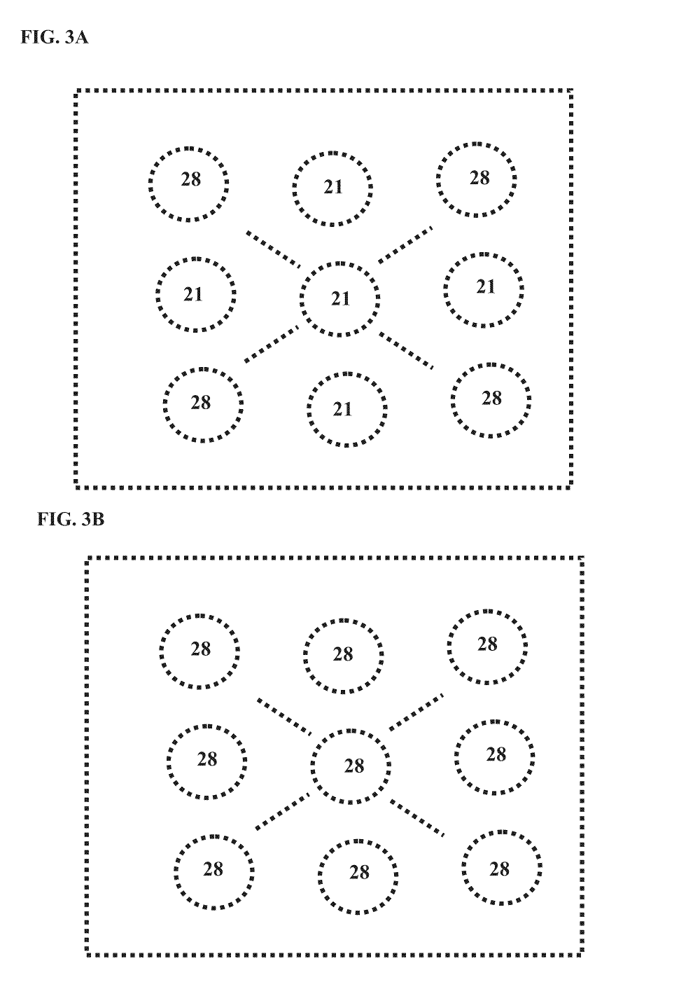

Other exemplary combinations of specific plants for planting within a square unit are represented in FIG. 3. These may include plants that require approximately 6 inch spacing as shown in FIG. 3 (Panel A). These plants include, but not limited to, cucumber, certain herbs, lettuce, and Swiss chard. Access holes (28) represent holes exposed for planting by tearing away the perforated center portion of access holes (21). Plants that do not require as much space may utilize all 9 access holes (28) for planting within a specific square as shown in FIG. 3 (Panel B). These plants may include beans, carrots, garlic, certain herbs, some lettuce, onions, peas, radish, and spinach.

The landscape fabric used in the present invention includes material known in the art and of suitable quality to incorporate an overlay guide in assisting gardeners to space their selection of plants or seeds during planting of raised vegetable garden beds. While a preferred embodiment includes landscape fabric capable of preventing weed growth for a single season before the fabric biodegrades, other landscape materials commonly known in the art are considered. The fabric should at a minimum protect against weed growth with or without an additional top covering of organic mulch, retain moisture in the soil, be strong enough (dry or wet) to stay intact the entire growing season, and provide an easy means of application. The fabric can be made from synthetic or organic materials, sometimes from recycled sources. A common type used in garden beds is a filter cloth type of fabric having a black color that will allow the soil is able to take up water and nutrients, yet still limit sunlight so as to prevent the weed seeds from germination. Optionally, the present invention further considers a colorant such as a dye or pigment that can be added to the fibers to improve opacity and to provide an aesthetically pleasing color. The overlay design must be a color that provides enough contrast to be readily detected by a gardener during use. For example, a landscape fabric having a black fabric would have an overlay color from a group comprising bright red, white, yellow, hot pink, lime green or combinations thereof.

Raised vegetable beds are designed to have dimensions that reflect the area where the bed will be located, the ease by which the gardener will access all areas of the bed, and a minimum amount of carpentry work necessary for making the bed. Consequently while all lengths of beds are considered in the present invention, raised vegetable beds most commonly are made of wood planks and have lengths of 4, 5, 8, 10 and 12 feet which reflect the lengths of planks offered for sale at the local lumber supply retailers or lengths of planks offered for sale which require only a single cut. Widths of approximately 2 to 4 feet represent the distance that an average size gardener will be able to access all sides of the bed. These lengths also represent the least number of cuts needed in building a raised bed, again from wood planks obtained from a local lumber supply retailers. Examples of typically-sized raised ve able beds include, but not limited to, 2 ft.×4 ft., 4 ft.×4 ft., 4 ft×8 ft., or 3 ft.×8 ft.

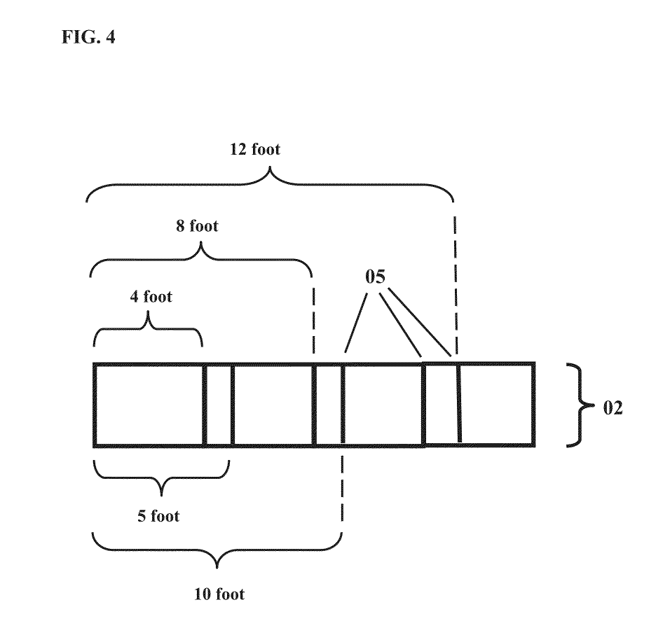

FIG. 4 depicts distances along a typical roll having a pre-formed perforation pattern that transects the roll at 4 foot intervals, 5 foot intervals, 8 foot intervals, 10 foot intervals or 12 foot intervals (05) and having a roll width (02). While other intervals are considered, these are the preferred patterns and reflect the more commonly used lengths in raised garden beds. Similar to the access holes described above, specific lengths have pre-formed perforations to allow the gardener to easily transect the roll at the specific bed length. The gardener simply places the roll at one end of the bed length and unravels the roll slightly beyond the selected length for the bed. Without the need of scissors or other cutting tools, the gardener tears along the pre-formed perforations to create a section of landscape fabric having the same dimensions as the bed. The section is secured to the bed itself or the garden soil. When properly secured in the bed, the gardener is then able to begin selecting the sites for the access holes based upon the gardener's desired planting scheme.

One method of the present invention incorporates the use of the landscape fabric defined above by a gardener in creating a raised vegetable garden bed. A landscape roll having a width of the raised bed is selected. The roll is then unraveled to a length slightly longer than the garden bed. Pre-formed perforations marking the length of the garden bed are torn to transect the roll at the bed length. The transected portion of the roll having the selected length is positioned across the planting surface of the garden bed and secured in place. The gardener determines a planting scheme across the planting surface of the bed using an online source or any preferred means. Access holes are selected based on the predetermined planting scheme and are created by tearing the pre-formed perforations at the site of the access hole located within the appropriate 12 inch square unit. For certain plants, an entire 12 in×12 in square unit may be removed for a specific plant type. Upon completion, the garden bed contains a selection of individual vegetable plants, appropriately spaced along the planting surface and properly secured to prevent infiltration by unwanted weeds.

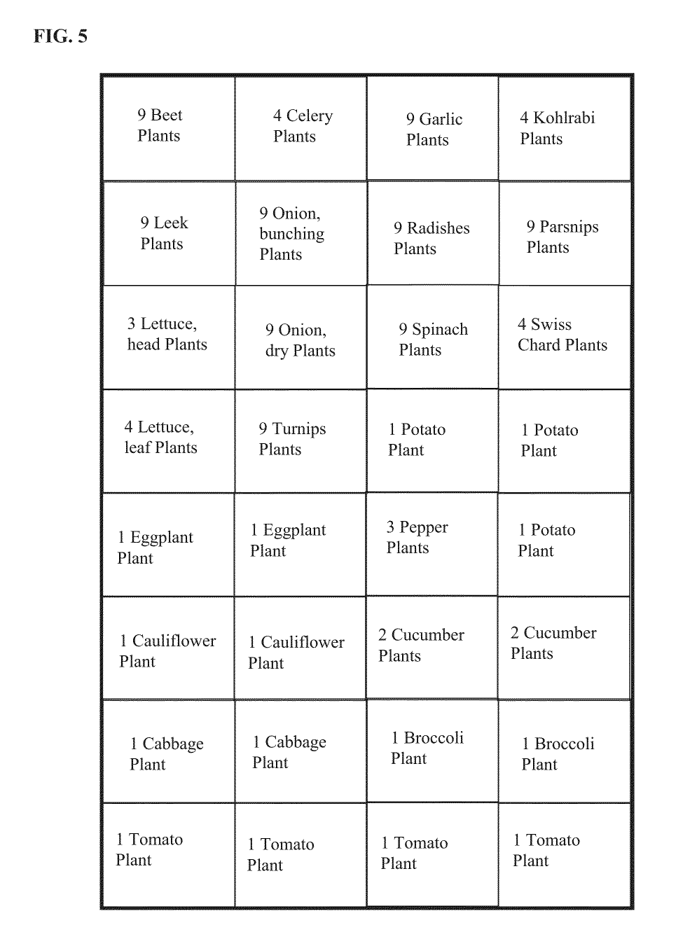

FIG. 5 depicts one possible planting scheme in a typical raised garden bed having properly spaced vegetable plants. In this example, a single 4 foot by 8 foot bed is able to incorporate 22 different plant varieties producing commonly eaten kitchen vegetables. Depending upon the required spacing, a single 12 in×12 in square unit is capable of maintaining 1 to 9 plants.

Those of ordinary skill in the art will recognize that various modification and variation may be made to the embodiments described above without departing from the spirit and scope of the present invention.

I claim,

1- A landscape fabric role for garden vegetable beds comprising:
a. landscape fabric wherein the fabric covers the planting surface; and
b. an overlay design on the surface of the landscape fabric for planting a selection of garden vegetable plants within a vegetable garden bed wherein the overlay provides access holes for optimum spacing of plants and wherein the landscape fabric provides weed protection.

2- The landscape fabric role of claim 1 having a linear perforation in the fabric width at defined lengths to cover the planting surface of the vegetable garden bed.

3- The landscape fabric of claim 2 wherein the planting surface is 2 ft×4 ft., 4 ft.×4 ft., 4 ft×8 ft., or 3 ft.×8 ft.

4- The landscape fabric of claim 1 wherein the overlay comprises 12 in×12 in square units containing 9 equally spaced access holes.

5- The landscape fabric of claim 4 wherein the access holes are pre-formed perforations.

6- The landscape fabric of claim 4 wherein the access holes have a 2.5 inch diameter.

7- The landscape fabric of claim 4 where the 12 in×12 in square units contain pre-formed perforations along a square unit perimeter.

8- The landscape fabric of claim 1 wherein the fabric is biodegradable.

9- The landscape fabric of claim 4 where at least one access hole has at least 4 additional equally-spaced linear perforations radiating from the center of the access hole.

10- The landscape fabric of claim 9 where the access hole having is a center access hole having 4 additional equally-spaced linear perforations.

11- A method for planting garden vegetables comprising:
a. covering a planting surface of a garden bed with a section fro landscape fabric role of claim 1; and
b. planting a selection of garden vegetable plants at access holes on the landscape fabric according to a predetermined scheme where the scheme provides optimum space and weed prevention for the selected plants.

12- The method of claim 11 having a fabric role of claim 2 wherein covering the section is by tearing perforations at a defined length.

13- The method of claim 11 wherein planting at access holes includes tearing selected pre-formed perforations.

14- The method of claim 13 wherein planting includes tearing pre-formed perforations along the perimeter of the 12 in×12 in square unit.

15- The method of claim 13 having a fabric role of claim 9 wherein planting of a large plant includes tearing selected per-formed perforations at an access hole having at least 4 additional equally-spaced linear perforations radiating from the center of the access hole.

16- A kit for preparing raised garden beds comprising:
a. a roll of landscape fabric of claim 1;
b. instructions on the use of landscape fabric in a garden bed; and
c. a selection of planting schemes wherein the scheme provides locations for typical plant varieties producing commonly eaten kitchen vegetables
